(19) United States
(12) Patent Application Publication
(10) Pub. No.: US 2024/0153392 A1
(43) Pub. Date: May 9, 2024

(54) A Method, System and an Apparatus for Connecting to Unconnected Drones with Positioning

(71) Applicant: Telia Company AB, SOLNA (SE)

(72) Inventor: Anders Baer, ÅRSTA (SE)

(73) Assignee: Telia Company AB, SOLNA (SE)

(21) Appl. No.: 18/281,404

(22) PCT Filed: Mar. 7, 2022
(86) PCT No.: PCT/SE2022/050218

§ 371 Date: Sep. 11, 2023

Related U.S. Application Data
(60) Provisional application No. 63/160,160, filed on Mar. 12, 2021.

(51) Int. Cl. G08G 5/00; H04W 64/00

(52) U.S. Cl. CPC G08G 5/0069; G08G 5/0017; H04W 64/003

(57) ABSTRACT

Methods, a system, and a user equipment (UE), for connecting to unconnected drones. The method includes a hand controller receiving a remote ID and positioning information from at least one drone. The hand controller extracts positioning coordinates from the received information and transmitting the remote ID and the extracted positioning coordinates to an Unmanned Aircraft Traffic Management (UTM) system which registers movement of at least one drone. UE within an area at a certain distance from the drone, transmits positioning coordinates of the UE to the UTM system which looks up the drones that are active within the area. The UTM system queries a database to provide information on registered users that are operating the drone in the area. The UTM system acquires, from the database, the queried information; and the UTM system transmits to the UE, the acquired information on the registered users.

### CROSS-REFERENCE TO RELATED APPLICATION

This application is a national stage application, filed under 35 U.S.C. § 371, of International Patent Application No. PCT/SE2022/050218 filed on Mar. 7, 2022, and U.S. Provisional Patent Application 63/160,160 filed on Mar. 12, 2021, which are incorporated by reference herein in their entirety.

### TECHNICAL FIELD

The present disclosure relates generally to the field of data communications, and more particularly to methods, systems and apparatuses, the system involving drones and user equipment(s) for connecting to unconnected drones or fleet of drones with positioning.

### BACKGROUND

In recent years, Unmanned Aircraft Systems (UAS), more commonly known as drones, have been used extensively in a large number of applications, ranging from aerial photography, agriculture, product delivery, inspection, hobbyist drone racing, military applications, law enforcement surveillance applications, such as used by the police and by national and international customs. Despite the usefulness of drones in many applications, they also pose increasing security, safety and privacy concerns. Drones are being used in unlawful activities, such as smuggling of illegal substances across territories, or illegal or non-allowed flying is areas making is difficult for law enforcement agencies or homeowners or the military control these movements. Regulatory agencies however are increasingly authorizing deployment of unmanned aerial or aircraft vehicles (drones), such as commercial drones.

To control a drone, a user equipment (UE) such as a hand-controller is commonly used. Examples of UEs include smart phones, tables computers, laptops, fly-controller etc. These UEs may also connect to terrestrial wireless networks, e.g., 3G, 4G, 5G LTE, 5G New Radio. When in fly mode or airplane mode, between, for example, takeoff and landing, these UEs are not-capable of connecting to terrestrial communication networks. Drones, on the other hand may operate at altitudes and speeds that are more suitable for connections to terrestrial wireless networks. For example, drones may operate at cruising altitudes at high speeds, e.g., 170 km/h.

As mentioned above, despite the usefulness of drones in many applications, they also pose increasing security, safety and privacy concerns, and law enforcement agencies, in some situations need to identify the drones and owners (pilots or users) of the drones for security reasons and/or for minimizing/reducing security risks in certain areas.

### SUMMARY

It is an object of embodiments herein to provide a solution in terms of methods, systems and apparatuses (hand-controller or UE(s)) for identifying or detecting drones or a fleet of drones in certain areas, which drones are initially not connected to the UEs. These drones are referred to here as unconnected drones.

According to an aspect of some embodiments herein there is provided a method in a system including at least one drone, at least one hand controller, a database an Unmanned Aircraft System Traffic Management (UTM) system and a device (e.g., a UE, or a mobile device, or a device equipped with Augmented Reality glasses) including a drone identification application, which may be in position of a law enforcement agency or any suitable agency for the purpose of the present invention.

Example of a method will be described in conjunction with the accompanying drawings. As part of the method, identification of one or more drones in an area may be performed by means of the device (mobile or UE or AR glasses or any UTM suitable hand-controller or mobile device for the purpose of this invention), wherein the device includes an application configured to utilize a device positioning logic, such as a Global Navigation Satellite System (GNSS) for positioning determination and/or a Global Positioning System (GPS) for positioning determination and/or means or capabilities utilizing terrestrial wireless communications networks (e.g. 3G, 4G, 5G LTE, 5G New Radio) for positioning determination (such as triangulation). The device may be owned by a law enforcement agency (such as police or military or official agency).

The application of the device may further comprise a compass to view or to sense in the direction towards the drone(s) of interest. The method hence includes acquiring or receiving, at the hand controller, the position (coordinates) from the drone and/or a drone's remote identification number (remote) D).

If the device or hand controller is equipped with Application Programming Interface (API) (like DJI (Da-Jiang Innovations®) application product for drones, the method includes extracting the positioning coordinates, by means of the API and transforming the drone hand controller property logic to a (selected) standard (e.g., a ISO standard) or to a common logic that is recognizable and understandable by a centralized function.

It should be mentioned that Standardization in the field of unmanned aircraft systems (UAS) is developed by ISO which stands for International Organization for Standardization. Many ISO standards are published, and additional ISO standards related to UAS are under development. An example of such an ISO standard document under development, i.e., which is not yet an established standard, is entitled “Unmanned aircraft systems—UAS Traffic Management (UTM)—Part 5: UTM functional structure”—ISO/CD 23629-5—ISO TC 20/SS 16/VVG4—which is available at https://www.iso.org/committee/5336224.html. Other parts of the standard are available at https://www.iso.org/committee/15336224/x/catalogue/p/1/u/0/w/0/d/0.

Referring back to the method, in case of an API, the API extracts the positioning information that is being exchanged between the drone and the hand controller. Then via the API, allows access (e.g., constructed in a Mobile App. of the hand controller) to control the payload (positioning info), and onboard computer. The API may reside in a Software Development Kit (SDK) that allows the application to control the payload (coordinates and/or remoteID (or droneID) etc.) and send the status to the Mobile app logic. The Mobile application could then transform the positioning data to the format of a chosen standard to be understandable for a UTM service in a UTM system. The positioning coordinates of the hand controller/device application may also be sent in relation to the drone information. The drone remoteID or droneID and its position is then sent the UTM system to register its movement.

According to an embodiment, the application for the device of the law enforcement agency sends the positioning coordinates of the device towards “UTM system service” to find related drones in the area of a certain distance from the device.

The UTM system service may then look up the drones that are active within the certain area (of the law enforcement officer).

The UTM system may then query an authority database including information on registered users (pilots) that are operating the drones in said area. The authority database may respond with user data (Name, contact details, etc.), and the UTM system service may respond back the registered user data for the drones that are within the area.

By means of a compass in the angle of direction that the device is pointed at will display the drone remoteID and related user data (operating pilot).

The law enforcement also acquires the positioning information about the pilot location since it is based on the hand controller/device application information. By that, the pilot can be reached by both the information from the registered information in the authority database as well as physical contact by sending, e.g., a law enforcement agent or authorized person to the location of pilot.

According to another aspect of embodiments herein, there is provided a system configurable to operate according to the method presented above. Additional details of actions performed in the system will be described in conjunction with the accompanying drawings.

In summary, according to an aspect of embodiments herein, there is provided a method in a system comprising at least one drone, at least one hand controller, a database, a UTM system and a UE. The method comprising: the hand controller receiving a remote Identification and positioning information from said at least one drone; the hand controller extracting positioning coordinates from the received information; the hand controller transmitting the remote ID and the extracted positioning coordinates to the UTM system; the UTM system registering movement of said at least one drone; the UE, within an area at a certain distance from said at least one drone, transmitting positioning coordinates of the UE to the UTM system; the UTM system looking up the at least one drone that are active within said area, based on the information received from the UE and information received from the hand controller; the UTM system querying the database to provide information on registered users that are operating said at least one drone in said area; the UTM system acquiring, from the database, the queried information on the registered users; and the UTM system transmitting, to the UE, the acquired information on the registered users.

According to another aspect of embodiments herein, there is provided a method performed by a UE (of a law enforcement agent) in a system comprising at least one drone, at least one hand controller, a database, and a UTM system, the method comprising: within an area at a certain distance from said at least one drone, transmitting or sending positioning coordinates of the UE to the UTM system, for enabling the UTM system to look up the at least one drone that are active within said area, based on the information received from the UE and information received from the hand controller; and the UTM system querying the database to provide information on registered users that are operating said at least one drone in said area; and receiving from the UTM system the information on the registered users.

According to another aspect of embodiments herein, there is provided a method performed by a UTM system in a system comprising at least one drone, at least one hand controller, a database, and a UE, the method comprising: receiving from the hand controller a remote ID (or drone ID) and extracted positioning coordinates of said at least one drone; registering movement of said at least one drone, receiving positioning coordinates of the UE, within an area at a certain distance from said at least one drone; looking up the at least one drone that are active within said area, based on the information received from the UE and information received from the hand controller; querying the database to provide information on registered users that are operating said at least one drone in said area; acquiring, from the database, the queried information on the registered users; and transmitting, to the UE, the acquired information on the registered users.

According to yet another aspect of embodiments herein, there is provided a system, according to the embodiments disclosed herein. The system comprising at least one drone, at least one hand controller, a database, a UTM system, and a User Equipment, wherein the entities in the system are configured or operative to perform the method according to any one of the embodiments disclosed herein.

According to yet another aspect of embodiments herein, there is provided a mobile device or UE operable by an agent (e.g., a law enforcement agent). The UE comprises a processor and a memory containing instructions executable by said processor, whereby the UE is configured to perform any one of the embodiments disclosed herein.

### BRIEF DESCRIPTION OF THE DRAWINGS

Example of embodiments herein are described in more detail with reference to attached drawings in which:

FIG. 1A is an architectural overview of a system involving the difference entities according to some exemplary embodiments.

FIG. 1B is yet another architectural overview of the system of FIG. 1A for determining at least the direction identity of at least one drone in a certain area.

FIG. 2 illustrates a block diagram of an exemplary UE according to embodiments herein.

FIG. 3 depicts a flowchart of a method performed in a system according to embodiments herein.

### DETAILED DESCRIPTION

In the following, a detailed description of the exemplary embodiments is presented in conjunction with the drawings to enable easier understanding of the solutions(s) described herein. It should be noted that the embodiments herein may be employed in any network topology or system involving any number drones, any number of hand controllers, devices or UEs, law enforcement agents, etc. A hand controller may also be viewed as a UE.

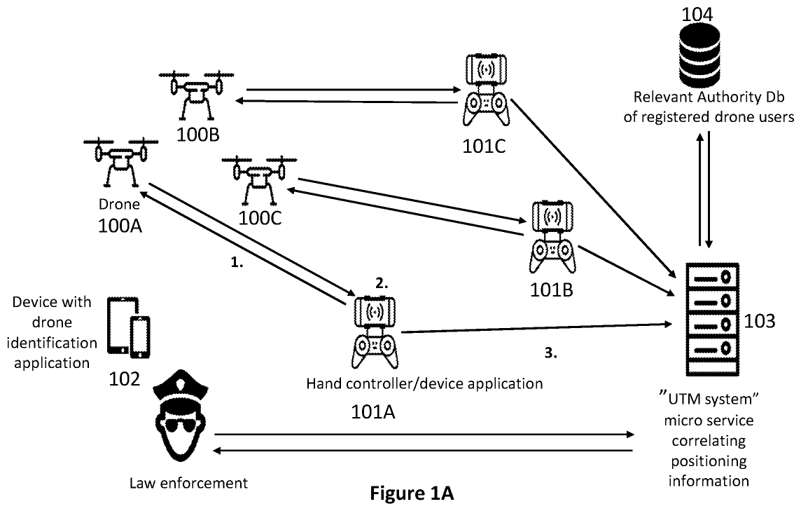

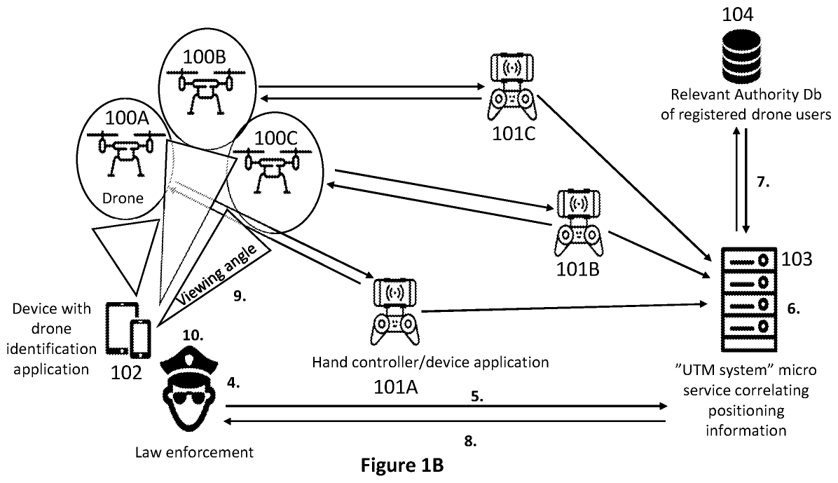

FIGS. 1A-1B depict an architectural system overview according to embodiments herein. As shown, the system includes a plurality of drones 100A, 100B, 100C; hand controllers 101A, 101B, 101C, each including a device application; a UE or a device 102 with a drone identification application which may be owned and/or controlled by a law enforcement agent or any suitable authority; a UTM system 103, which includes a (micro) service for correlating positioning information retrieved from the hand controller(s) and a database (dB) 104 which may be an authority database which includes information on registered (drone) users.

FIGS. 1A-1B also include numbering 1-9 depicting actions performed in the system according to some embodiments herein.

Referring to FIG. 1A, details of the method performed in the system are described:

In step 1: A drone (e.g., 100A) communicates its remote identification information or remoteID (or droneID) and positioning information (or coordinates) (by means of GNSS, GPS or wireless terrestrial networks) to a hand controller 101A which in itself is a device or a UE. For the sake of simplicity, the device 101A is referred to as a drone hand controller.

In step 2: the drone hand controller 101A receives the remoteID or the droneID and positioning coordinates. If the drone hand controller is equipped with an API (as previously described), the positioning coordinates are extracted. An application logic may be constructed to transform the drone hand controller proprietary logic to a selected standard or to a common logic that can be understood by a centralized function. The positioning coordinates of the hand controller/device application are also sent in relation to the drone information.

The API allows access (e.g., constructed in a Mobile App) to control the payload (positioning info), and onboard computer. The API may reside in an SDK that allows the application to control the payload and sends status to the Mobile app logic. The Mobile application could then transform the positioning data to the format of chosen standard to be understandable for a UTM service.

In step 3: The drone remoteID or droneID and the positioning or coordinates to the UTM system 103. The information received at the UTM system 103 may be used to register the movement(s) of the drone. A service correlation positioning information resides in the UTM system 103.

The droneID or remoteID may include two parts: the identity of the drone (with a drone registered ID) and the pilot identity (which is located in a centralized system e.g., a database).

There should be an identity of the hand controller operating a specific drone. And this identity is also sent over the API towards the UTM system 103. This creates a relation between drone—hand controller, that could later on act as proof of that the hand controller and logged in pilot was actually the one operating the drone.

In step 4: A law enforcement agency or agent needs to identify one or more drones in a certain area. A law enforcement officer uses an application on a mobile device or UE 102 (or potentially AR glasses) that utilizes the device positioning logic (GNSS, GPS, mobile etc.) available and a compass in the device to view in the direction (viewing angle) towards the drone(s) of interest e.g., drones 100A-100C.

In step 5: The application in the mobile device 102 sends the positioning coordinates of the device towards the “UTM system service” to find related drones in the area at certain a distance from the device 102.

In step 6: The UTM system service 103 looks up or checks up the drones that are active within the certain area (of the law enforcement officer).

In step 7: The UTM system 103 then queries the authority database 104 which includes the registered users (pilots) that are operating the drones in the requested area. The authority database responds with user data (Name, contact details etc.)

In step 8: The UTM system service 103 responds back to the law enforcement agent or to the device 102, the registered user data for the drones that are within the area.

In step 9: With the use of the compass in device 102, the angle of direction that the device 102 is pointed at display in the device 102 the drone remoteID and related user data (operating pilot (user)).

In step 10: The law enforcement agent also acquires the positioning information about the pilot location since it based on the hand controller/device application information. By this, the pilot can be reached through both information from the registered information in the authority database 104 as well as the physical contact by sending someone to the location of the pilot.

The proposed logic according to embodiments herein may use sensors in the device, e.g., a compass to fetch the direction the device (requestor) (law enforcement agent) is viewing the sky. The direction angle of where the device is viewing together with the positioning information of the device itself would be communicated to the “centralized correlating positioning information” function in the. UTM system 103.

The “centralized correlating positioning information” in the UTM system 103 would then retrieve the previously collected positioning information and droneID from the drones (via the hand controller(s)) that are within the area that the device of the requestor (law enforcement) is located in and that is within the viewing angle of requestor.

The distance of area could either be configured or stipulated be settings (permissions) The information about the hand controller and or the device logic extracting positioning would also be sent and related to the drone positioning.

According to an embodiment, a drone (e.g., drone 100A) may provide the hand controller 101A/mobile device/application residing in the hand controller 101A, with a stream of data, e.g., a stream of image frames in the form of video in addition to the positioning coordinates of the drone 100A.

If the available positioning coordinates for a given point of the drone was to be added to each of the image frames generated by a sensor (some camera) at the drone 100A, the data could both be extracted in the hand control/mobile device/application 101A as well as be used if the image frame was to be sent further on (similar to suggestion of positioning coordinates) to a service where it is broadcasted to a target of interest (e.g., someone viewing the image stream).

The benefit would be that it would be possible to generate a layer of new image frames in relation to a map (based on older generated frames), and by that perform a comparison between the new image frames to spot changes in the map (current versus previously generated). The positioning information may then be used as a reference point to achieve synchronization between the image frames.

The different actions performed by the different entities involved in the system as shown in FIG. 1A or FIG. 1B have already been described and need not be repeated again.

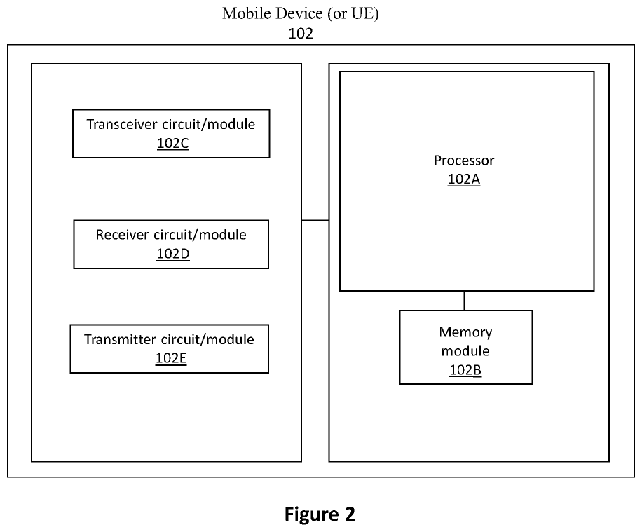

Referring to FIG. 2 there is illustrated an exemplary block diagram of a mobile device 102 for performing the functions described herein. It should be noted that although FIG. 2 illustrates a mobile device and the components therein, the methods of identifying of one or more drones in an area may be performed by means of a UE or another mobile device, e.g., AR glasses or any UTM suitable hand-controller or mobile device. Thus, the components of the mobile device 102 shown in FIG. 2 can also be components in any of the afore-mentioned devices.

Mobile device 102 comprises a processing circuit or a processing module or a processor 102A; a memory module 102B; a receiver circuit or receiver module 102D; a transmitter circuit or transmitter module 102E; and a transceiver circuit or transceiver module 102C which may include the transmitter circuit 102E and the receiver circuit 102D. The mobile device 102 may support any of radio access technologies including 2G, 3G, 4G, 5G, Wifi, Wimax or a combination thereof. The mobile device 102 may include a camera, a GPS receiver, an audio codec coupled to a speaker, a microphone, and an earphone jack. The mobile device 102 may also include a display controller (e.g., a touchscreen controller) which provides a graphical output to a display and in input from a touch input device. Collectively, the display device and touch input device may be referred to as touchscreen. The mobile device 102 is capable of communicating wirelessly to the Internet via WiFi or any wireless access technology mentioned above. The mobile device or UE 102 may include additional component, entities, means or devices not shown in FIG. 2.

The processing module/circuit 102A includes a processor, microprocessor, an application specific integrated circuit (ASIC), field programmable gate array (FPGA), or the like, and may be referred to as the “processor 102A.” The processor 102A controls the operation of the mobile device 102 and its components. Memory (circuit or module) 102B includes a random-access memory (RAM), a read only memory (ROM), and/or another type of memory to store data and instructions that may be used by processor 102A.

The processor 102A is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions stored in the memory specially adapts or configures the processor 102A to carry out the operations of the UE 102 disclosed herein. The UE 102, comprising the processor 102A and the memory 102B containing instructions executable by said processor 102A, whereby the UE 102 is configured or is operative to perform any one of the embodiments disclosed herein.

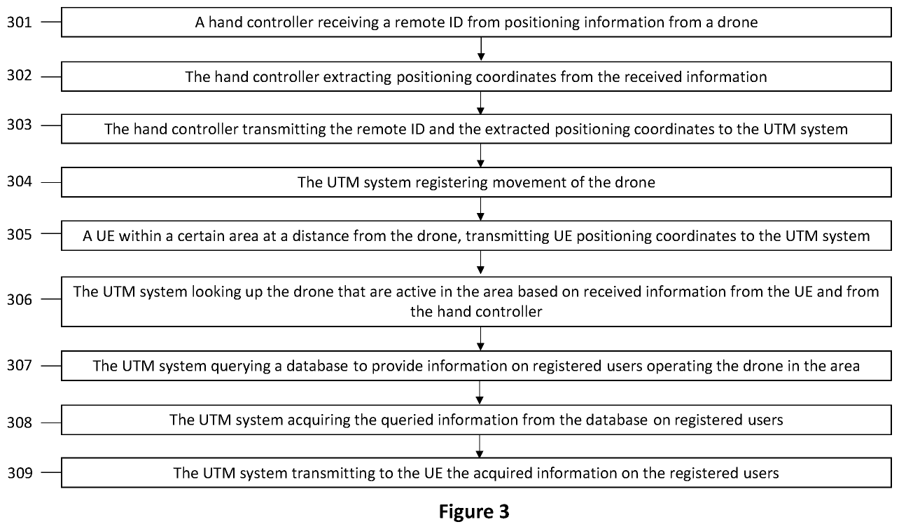

Referring to FIG. 3, there is illustrated a flowchart of a method performed in the system according to previously described embodiments. As mentioned, and illustrated in FIGS. 1A-1B, the system comprises: at least one drone 100A-100C, at least one hand controller 101A-101C, a database 104, a UTM system 103 and a UE 102. As shown, the method comprises:
the hand controller 101A-101C receiving (301) a remote Identification (ID) (or a drone ID) and positioning information from said at least one drone 100A-100C;
the hand controller 101A-101C extracting (302) positioning coordinates from the received information;
the hand controller 101A-101C transmitting (303) the remote ID (or drone ID) and the extracted positioning coordinates to the UTM system 103;
the UTM system 103 registering (304) movement of said at least one drone 100A-1000,
the UE 102, within an area at a certain distance from said at least one drone 100A-100C, transmitting (305) positioning coordinates of the UE 102 to the UTM system 103;
the UTM system 103 looking up (306) the at least one drone 100A-100C that are active within said area, based on the information received from the UE 102 and information received from the hand controller 101A-101C;
the UTM system 103 querying (307) the database 104 to provide information on registered users that are operating said at least one drone 100A-100C in said area;
the UTM system 103 acquiring (308), from the database 104, the queried information on the registered users; and
the UTM system 103 transmitting (309), to the UE 102, the acquired information on the registered users.

As previously described the remote ID (or the drone ID) includes two parts: the remote ID or the drone ID and an ID of a pilot or registered user operating the drone 100A-100C.

According to an embodiment, the method further comprises, displaying in the UE 102, the remote ID (or drone ID) and information on the registered users operating the drone 100A-100C having the drone ID.

According to an embodiment, the drone 100A-100C provides the hand controller 101A-101C with a stream of data or image frames in the form of video in addition to providing said positioning information of the drone 100A-100C.

Additional actions and operations performed by the entities included in the system have been described and need not be repeated.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

Throughout this disclosure, the word “comprise” or “comprising” has been used in a non-limiting sense, i.e., meaning “consist at least of”. Although specific terms may be employed herein, they are used in a generic and descriptive sense only and not for purposes of limitation. The embodiments herein may be applied in any wireless systems including 3G, LTE or 4G, LTE-A (or LTE-Advanced), 5G, advanced 5G, WiMAX, WiFi, satellite communications, TV broadcasting etc.

1-10. (canceled)

11. A method in a system comprising at least one drone, at least one hand controller, a database, an Unmanned Aircraft Traffic Management (UTM) system and a User equipment (UE), the method comprising:
the hand controller receiving a remote Identification (ID) or a drone ID, and positioning information from said at least one drone;
the hand controller extracting positioning coordinates from the received information;
the hand controller transmitting the remote ID or the drone ID and the extracted positioning coordinates to the UTM system;
the UTM system registering movement of said at least one drone;
the UE, within an area at a certain distance from said at least one drone, transmitting positioning coordinates of the UE to the UTM system;
the UTM system looking up the at least one drone that are active within said area, based on the information received from the UE and information received from the hand controller;
the UTM system querying the database to provide information on registered users that are operating said at least one drone in said area;
the UTM system acquiring, from the database, the queried information on the registered users; and
the UTM system transmitting, to the UE, the acquired information on the registered users.

12. The method according to claim 11, wherein the remote ID or the drone ID includes two parts: the remote ID or the drone ID, and an ID of a pilot or registered user operating the drone.

13. The method according to claim 11, further comprising displaying in the UE, the remote ID or the drone ID, and information on the registered users operating the drone having the drone ID.

14. The method according to claim 11, wherein the drone provides the hand controller with a stream of data or image frames in the form of video in addition to providing said positioning information of the drone.

15. A method performed by a User Equipment (UE) in a system comprising at least one drone, at least one hand controller, a database, and an Unmanned Aircraft Traffic Management (UTM) system, the method comprising:
within an area at a certain distance from said at least one drone, transmitting positioning coordinates of the UE to the UTM system, for enabling the UTM system to look up the at least one drone that are active within said area, based on the information received from the UE and information received from a hand controller; and the UTM system querying the database to provide information on registered users that are operating said at least one drone in said area; and
receiving from the UTM system the information on the registered users.

16. The method according to claim 15, further comprising displaying in the UE, a remote ID or a drone ID, and information on the registered users operating the drone having the drone ID.

17. A method performed by an Unmanned Aircraft Traffic Management UTM system in a system comprising at least one drone, at least one hand controller, a database, and a User Equipment, UE, the method comprising:
receiving from the hand controller a remote ID or a drone ID and extracted positioning coordinates of said at least one drone;
registering movement of said at least one drone;
receiving positioning coordinates of the UE, within an area at a certain distance from said at least one drone;
looking up the at least one drone that are active within said area, based on the information received from the UE and information received from the hand controller;
querying the database to provide information on registered users that are operating said at least one drone in said area;
acquiring, from the database, the queried information on the registered users; and
transmitting, to the UE, the acquired information on the registered users.

18. The method according to claim 17, wherein the remote ID, or the drone ID, includes two parts: the remote ID or the drone ID and an ID of a pilot or registered user operating the drone.

19. A User Equipment (UE) comprising a processor and a memory containing instructions executable by said processor whereby the UE is configured to:
within an area at a certain distance from said at least one drone, transmit positioning coordinates of the UE to the UTM system, for enabling the UTM system to look up the at least one drone that are active within said area, based on the information received from the UE and information received from a hand controller; and the UTM system querying the database to provide information on registered users that are operating said at least one drone in said area; and
receive from the UTM system the information on the registered users.

20. A system comprising at least one drone, at least one hand controller, a database, an Unmanned Aircraft Traffic Management (UTM) system and a User equipment (UE), wherein:
the hand controller is configured to receive a remote Identification (ID) or a drone ID, and positioning information from said at least one drone;
the hand controller being configured to extract positioning coordinates from the received information;
the hand controller being configured to transmit the remote ID or drone ID, and the extracted positioning coordinates to the UTM system;
the UTM system configured to register movement of said at least one drone;
the UE, within an area at a certain distance from said at least one drone, configured to transmit positioning coordinates of the UE to the UTM system;
the UTM system configured to look up the at least one drone that are active within said area, based on the information received from the UE and information received from the hand controller;
the UTM system configured to query the database to provide information on registered users that are operating said at least one drone in said area;
the UTM system configured to acquire, from the database, the queried information on the registered users; and
the UTM system configured to transmit, to the UE, the acquired information on the registered users.
